(19) United States
(12) Patent Application Publication
(10) Pub. No.: US 2024/0430951 A1
(43) Pub. Date: Dec. 26, 2024

(54) SIGNAL TRANSMISSION METHOD AND RELATED APPARATUS

(71) Applicant: Huawei Technologies Co., Ltd., Shenzhen (CN)

(72) Inventors: Fan Wei, Shenzhen (CN); Jiaqi Fang, Nanjing (CN); Wenjin Wang, Nanjing (CN); Lei Wang, Shanghai (CN)

(21) Appl. No.: 18/829,838

(22) Filed: Sep. 10, 2024

Related U.S. Application Data
(63) Continuation of application No. PCT/CN2023/079925, filed on Mar. 6, 2023.

(30) Foreign Application Priority Data
Mar. 11, 2022 (CN) 202210242741.5

(51) Int. Cl. H04W 74/0833; H04W 72/044

(52) U.S. Cl. CPC H04W 74/0833; H04W 72/044

(57) ABSTRACT

The first terminal device groups to-be-sent information bits to obtain first information bits and second information bits; separately encodes the first information bits and the second information bits to obtain a first codeword sequence and a second codeword sequence; then performs interleaving processing on the first codeword sequence and the second codeword sequence based on an interleaving pattern, to obtain a first target signal; and sends the first target signal to the access network device. The access network device performs de-interleaving processing on the received first target signal based on a preset interleaving pattern, to obtain the first codeword sequence and the second codeword sequence; and separately decodes the first codeword sequence and the second codeword sequence to obtain the first information bits and the second information bits.

### CROSS-REFERENCE TO RELATED APPLICATIONS

This application is a continuation of International Application No. PCT/CN2023/079925, filed on Mar. 6, 2023, which claims priority to Chinese Patent Application No. 202210242741.5, filed on Mar. 11, 2022. The disclosures of the aforementioned applications are hereby incorporated by reference in their entireties.

### TECHNICAL FIELD

This application relates to the field of communication technologies, and in particular, to a signal transmission method and a related apparatus.

### BACKGROUND

In a wireless communication system, multiplexing of a time domain resource, a frequency domain resource, a space domain resource, and other resources by a plurality of users should be given special consideration. Currently, a passive random multiple access model is proposed, to implement user access in a resource pre-configuration manner. To be specific, a specific quantity of communication resources is pre-configured for a terminal device in a network, and a user accesses a network device in a random and contention-based manner based on service arrival of the user.

Based on the passive random multiple access model, an existing signal transmission method may include: A signal transmit end divides information bits into two groups that are respectively denoted as a group 1 of information bits wₚ and a group 2 of information bits w_{c}, and selects a codeword from a randomly generated codebook set A based on the group 1 of information bits wₚ. A quantity of codeword sequences in the codebook set A is: M=2^{p}, p is a quantity of bits of the group 1 of information bits wₚ, and the codebook set A is the same for all user equipment. Each information bit in the group 2 of information bits w_{c} is sequentially processed by a low density parity check (low density parity check, LDPC) code channel encoder, a repetition module, a zero-filling module, an interleaving module, and the like to generate a multi-user code codeword. A quantity of repetitions and an interleaving pattern are determined based on the group 1 of information bits wₚ. A signal generated based on the group 1 of information bits and a signal generated based on the group 2 of information bits are concatenated to generate a final codeword, and the final codeword is sent to a signal receive end. However, signal transmission accuracy of the existing signal transmission method is low.

Therefore, based on the passive random multiple access model, how to improve the signal transmission accuracy becomes an urgent problem to be resolved.

### SUMMARY

This application provides a signal transmission method and a related apparatus, to improve signal transmission accuracy based on a passive random multiple access model.

According to a first aspect, this application provides a signal transmission method. The method is performed by a first terminal device, the first terminal device accesses an access network device in a passive random multiple access manner, and the method includes: grouping to-be-sent information bits to obtain first information bits and second information bits; encoding the first information bits to obtain a first codeword sequence; encoding the second information bits to obtain a second codeword sequence; performing interleaving processing on the first codeword sequence and the second codeword sequence based on an interleaving pattern, to obtain a first target signal; and sending the first target signal to the access network device.

In this method, the first terminal device accesses the access network device in the passive random multiple access manner. The first terminal device separately encodes the first information bits and the second information bits to obtain the first codeword sequence and the second codeword sequence. The first codeword sequence is equivalent to a pilot, and the second codeword sequence includes to-be-transmitted information. Then, the first terminal device performs interleaving processing on the first codeword sequence and the second codeword sequence based on the interleaving pattern, to obtain the first target signal, and sends the first target signal to the access network device. In comparison with a target signal obtained by processing the first codeword sequence and the second codeword sequence through concatenation, in the target signal obtained by performing interleaving processing on the first codeword sequence and the second codeword sequence based on the interleaving pattern, the first codeword sequence and the second codeword sequence can be distributed as evenly as possible, that is, a pilot signal and a to-be-transmitted signal can be evenly distributed. In this way, the obtained target signal is more suitable for a scenario in which a channel changes rapidly, and signal transmission accuracy is improved.

In a possible implementation, the method further includes: receiving first configuration information from the access network device, where the first configuration information indicates the interleaving pattern.

In this implementation, the interleaving pattern used by the first terminal device to perform interleaving processing on the first codeword sequence and the second codeword sequence is an interleaving pattern indicated by the access network device, so that the interleaving pattern used by the first terminal device to perform interleaving processing is the same as an interleaving pattern used by the access network device to perform de-interleaving processing, thereby improving signal transmission efficiency, and improving signal transmission accuracy.

In a possible implementation, the interleaving pattern satisfies the following relational expression: s=h (cell_{id},ratio). s represents the interleaving pattern, h(⋅) represents an interleaving function, cell_{id} represents an identity of a cell in which the first terminal device is located, and ratio represents a ratio of a length of the first codeword sequence to a length of the second codeword sequence.

In a possible implementation, the method further includes: receiving second configuration information from the access network device, where the second configuration information indicates a codebook set, and the codebook set is constructed by the access network device in a tensor manner or a matrix extraction manner.

In this implementation, the codebook set received by the first terminal device from the access network device is constructed by the access network device in the tensor manner or the matrix extraction manner. Compared with constructing a codebook set by the access network device based on experience or randomly generating a codebook set by a system, this improves accuracy of decoding at a signal receive end.

In a possible implementation, the encoding the first information bits to obtain a first codeword sequence includes: performing selection from the codebook set based on the first information bits, to obtain the first codeword sequence.

In this implementation, the first terminal device performs selection from the codebook set constructed by the access network device in the tensor manner or the matrix extraction manner, to obtain the first codeword sequence based on the first information bits, thereby improving accuracy of transmitting the first information bits, and improving signal transmission accuracy.

In a possible implementation, the encoding the second information bits to obtain a second codeword sequence includes: encoding the second information bits based on a channel encoding/decoding type and a non-orthogonal multiple access type, to obtain the second codeword sequence.

In this implementation, the first terminal device encodes the second information bits based on the channel encoding/decoding type and the non-orthogonal multiple access type, to obtain the second codeword sequence, thereby improving encoding efficiency and encoding accuracy of the second information bits, and improving signal transmission efficiency and transmission accuracy.

In a possible implementation, the method further includes: receiving third configuration information from the access network device, where the third configuration information indicates the channel encoding/decoding type and the non-orthogonal multiple access type.

In this implementation, the first terminal device encodes the second information bits based on the channel encoding/decoding type and the non-orthogonal multiple access type that are indicated by the access network device, to obtain the second codeword sequence, so that the channel encoding/decoding type and the non-orthogonal multiple access type that are used by the first terminal device for encoding are the same as a channel encoding/decoding type and a non-orthogonal multiple access type that are used by the access network device for decoding, thereby improving transmission efficiency of the second codeword sequence, and improving transmission accuracy of the second codeword sequence.

In a possible implementation, the method further includes: determining a parameter of the non-orthogonal multiple access type based on the first information bits.

In this implementation, the first terminal device determines the parameter of the non-orthogonal multiple access type based on the first information bits, thereby improving encoding efficiency and encoding accuracy of the second information bits, and improving signal transmission efficiency and transmission accuracy.

In a possible implementation, the method further includes: receiving a second target signal from a second terminal device; performing de-interleaving processing on the second target signal to obtain a third codeword sequence and a fourth codeword sequence; decoding the third codeword sequence to obtain third information bits; and decoding the fourth codeword sequence to obtain fourth information bits.

In this implementation, the first terminal device may be used as a signal transmit end to send the first target signal to the access network device, or may be used as a signal receive end to receive the second target signal from the second terminal device, perform de-interleaving processing on the second target signal to obtain the third codeword sequence and the fourth codeword sequence, and then separately decode the third codeword sequence and the fourth codeword sequence to obtain the third information bits and the fourth information bits.

According to a second aspect, this application provides a signal transmission method. The method is performed by an access network device, and the method includes: receiving a first target signal from a first terminal device, where the first terminal device accesses the access network device in a passive random multiple access manner; performing de-interleaving processing on the first target signal based on a preset interleaving pattern, to obtain a first codeword sequence and a second codeword sequence; decoding the first codeword sequence to obtain first information bits; and decoding the second codeword sequence to obtain second information bits.

In this method, the first terminal device accesses the access network device in the passive random multiple access manner. The access network device performs, based on the preset interleaving pattern, de-interleaving processing on the first target signal received from the first terminal device, to obtain the first codeword sequence and the second codeword sequence, and separately decodes the first codeword sequence and the second codeword sequence to obtain the first information bits and the second information bits. The first target signal is obtained by performing interleaving processing by the first terminal device on the first codeword sequence and the second codeword sequence based on the interleaving pattern, to enable the first codeword sequence and the second codeword sequence in the first target signal to be evenly distributed, so that the first target signal is more suitable for a scenario in which a channel changes rapidly, and signal transmission accuracy is improved.

In a possible implementation, the method further includes: sending first configuration information to the first terminal device, where the first configuration information indicates the interleaving pattern.

In this implementation, the access network device indicates the interleaving pattern to the first terminal device, so that an interleaving pattern used by the first terminal device to perform interleaving processing is the same as the interleaving pattern used by the access network device to perform de-interleaving processing, thereby improving signal transmission efficiency, and improving signal transmission accuracy.

In a possible implementation, the interleaving pattern satisfies the following relational expression: s=h (cell_{id},ratio). s represents the interleaving pattern, h(⋅) represents an interleaving function, cell_{id} represents an identity of a cell in which the first terminal device is located, and ratio represents a ratio of a length of the first codeword sequence to a length of the second codeword sequence.

In a possible implementation, the method further includes: constructing a codebook set in a tensor manner or a matrix extraction manner, where the codebook set is used for transmitting the first information bits; and sending second configuration information to the first terminal device, where the second configuration information indicates the codebook set.

In this implementation, the access network device constructs the codebook set based on the tensor manner or the matrix extraction manner. Compared with constructing a codebook set based on experience or randomly generating a codebook set by a system, this improves accuracy of the codebook set. In addition, the access network device indicates the codebook set to the first terminal device, so that the first terminal device performs selection from the codebook set based on the first information bits, to obtain the first codeword sequence, thereby improving accuracy of transmitting the first information bits, and improving signal transmission accuracy.

In a possible implementation, the decoding the first codeword sequence to obtain first information bits includes: decoding the first codeword sequence based on the codebook set, to obtain the first information bits.

In this implementation, the access network device decodes the first codeword sequence based on the codebook set indicated to the first terminal device, to obtain the first information bits, so that a codebook set used by the first terminal device for encoding is the same as the codebook set used by the access network device for decoding, thereby improving signal transmission efficiency, and improving signal transmission accuracy.

In a possible implementation, the method further includes: determining a channel encoding/decoding type and a non-orthogonal multiple access type; and sending third configuration information to the first terminal device, where the third configuration information indicates the channel encoding/decoding type and the non-orthogonal multiple access type.

In this implementation, the access network device determines the channel encoding/decoding type and the non-orthogonal multiple access type, and indicates the channel encoding/decoding type and the non-orthogonal multiple access type to the first terminal device, so that the first terminal device can encode the second information bits based on the channel encoding/decoding type and the non-orthogonal multiple access type that are indicated by the access network device, to obtain the second codeword sequence, thereby improving encoding efficiency and encoding accuracy of the second information bits, and improving signal transmission efficiency and transmission accuracy.

In a possible implementation, the decoding the second codeword sequence to obtain second information bits includes: decoding the second codeword sequence based on the channel encoding/decoding type and the non-orthogonal multiple access type, to obtain the second information bits.

In this implementation, the access network device decodes the second codeword sequence based on the channel encoding/decoding type and the non-orthogonal multiple access type that are indicated to the first terminal device, to obtain the second information bits, so that a channel encoding/decoding type and a non-orthogonal multiple access type that are used by the first terminal device for encoding are the same as the channel encoding/decoding type and the non-orthogonal multiple access type that are used by the access network device for decoding, thereby improving signal transmission efficiency, and improving signal transmission accuracy.

In a possible implementation, the method further includes: determining a parameter of the non-orthogonal multiple access type based on the first information bits.

In this implementation, the access network device determines the parameter of the non-orthogonal multiple access type based on the first information bits, thereby improving decoding efficiency and decoding accuracy of the second information bits, and improving signal transmission efficiency and transmission accuracy.

According to a third aspect, this application provides a signal transmission apparatus. The apparatus includes: a grouping module, configured to group to-be-sent information bits to obtain first information bits and second information bits; an encoding module, configured to encode the first information bits to obtain a first codeword sequence, and further configured to encode the second information bits to obtain a second codeword sequence; a processing module, configured to perform interleaving processing on the first codeword sequence and the second codeword sequence based on an interleaving pattern, to obtain a first target signal; and a sending module, configured to send the first target signal to an access network device.

In a possible implementation, the apparatus further includes a receiving module. The receiving module is configured to receive first configuration information from the access network device, where the first configuration information indicates the interleaving pattern.

In a possible implementation, the interleaving pattern satisfies the following relational expression: s=h (cell_{id},ratio). s represents the interleaving pattern, h(⋅) represents an interleaving function, cell_{id} represents an identity of a cell in which a first terminal device is located, and ratio represents a ratio of a length of the first codeword sequence to a length of the second codeword sequence.

In a possible implementation, the receiving module is further configured to: receive second configuration information from the access network device, where the second configuration information indicates a codebook set, and the codebook set is constructed by the access network device in a tensor manner or a matrix extraction manner.

In a possible implementation, the encoding module is specifically configured to: perform selection from the codebook set based on the first information bits, to obtain the first codeword sequence.

In a possible implementation, the encoding module is specifically configured to: encode the second information bits based on a channel encoding/decoding type and a non-orthogonal multiple access type, to obtain the second codeword sequence.

In a possible implementation, the receiving module is further configured to: receive third configuration information from the access network device, where the third configuration information indicates the channel encoding/decoding type and the non-orthogonal multiple access type.

In a possible implementation, the apparatus further includes a determining module. The determining module is configured to determine a parameter of the non-orthogonal multiple access type based on the first information bits.

In a possible implementation, the receiving module is further configured to receive a second target signal from a second terminal device; and the processing module is further configured to perform de-interleaving processing on the second target signal to obtain a third codeword sequence and a fourth codeword sequence. The apparatus further includes a decoding module. The decoding module is configured to decode the third codeword sequence to obtain third information bits; and the decoding module is further configured to decode the fourth codeword sequence to obtain fourth information bits.

For beneficial effects of the third aspect and the possible implementations of the third aspect, refer to beneficial effects of the first aspect and the possible implementations of the first aspect. Details are not described herein again.

According to a fourth aspect, this application provides a signal transmission apparatus. The apparatus includes: a receiving module, configured to receive a first target signal from a first terminal device, where the first terminal device accesses an access network device in a passive random multiple access manner; a processing module, configured to perform de-interleaving processing on the first target signal based on a preset interleaving pattern, to obtain a first codeword sequence and a second codeword sequence; and a decoding module, configured to decode the first codeword sequence to obtain first information bits, and further configured to decode the second codeword sequence to obtain second information bits.

In a possible implementation, the apparatus further includes a sending module. The sending module is configured to: send first configuration information to the first terminal device, where the first configuration information indicates the interleaving pattern.

In a possible implementation, the interleaving pattern satisfies the following relational expression: s=h (cell_{id},ratio). s represents the interleaving pattern, h(⋅) represents an interleaving function, cell_{id} represents an identity of a cell in which the first terminal device is located, and ratio represents a ratio of a length of the first codeword sequence to a length of the second codeword sequence.

In a possible implementation, the apparatus further includes a construction module. The construction module is configured to construct a codebook set in a tensor manner or a matrix extraction manner, where the codebook set is used for transmitting the first information bits; and the sending module is further configured to send second configuration information to the first terminal device, where the second configuration information indicates the codebook set.

In a possible implementation, the decoding module is specifically configured to: decode the first codeword sequence based on the codebook set, to obtain the first information bits.

In a possible implementation, the apparatus further includes a determining module. The determining module is configured to determine a channel encoding/decoding type and a non-orthogonal multiple access type; and the sending module is further configured to send third configuration information to the first terminal device, where the third configuration information indicates the channel encoding/decoding type and the non-orthogonal multiple access type.

In a possible implementation, the decoding module is specifically configured to: decode the second codeword sequence based on the channel encoding/decoding type and the non-orthogonal multiple access type, to obtain the second information bits.

In a possible implementation, the determining module is further configured to: determine a parameter of the non-orthogonal multiple access type based on the first information bits.

For beneficial effects of the fourth aspect and the possible implementations of the fourth aspect, refer to beneficial effects of the second aspect and the possible implementations of the second aspect. Details are not described herein again.

According to a fifth aspect, this application provides a signal transmission apparatus. The apparatus may include a processor coupled to a memory. The memory is configured to store program code, and the processor is configured to execute the program code in the memory, to implement the method according to any one of the first aspect, the second aspect, or the implementations of the first aspect or the second aspect.

Optionally, the apparatus may further include the memory.

According to a sixth aspect, this application provides a chip, including at least one processor and a communication interface, where the communication interface and the at least one processor are interconnected via a line, and the at least one processor is configured to run a computer program or instructions, to perform the method according to any one of the first aspect, the second aspect, or the possible implementations of the first aspect or the second aspect.

According to a seventh aspect, this application provides a computer-readable medium, where the computer-readable medium stores program code executed by a device, and the program code includes the method according to any one of the first aspect, the second aspect, or the possible implementations of the first aspect or the second aspect.

According to an eighth aspect, this application provides a computer program product including instructions. When the computer program product runs on a computer, the computer is enabled to perform the method according to any one of the first aspect, the second aspect, or the possible implementations of the first aspect or the second aspect.

According to a ninth aspect, this application provides a computing device, including at least one processor and a communication interface, where the communication interface and the at least one processor are interconnected via a line, the communication interface communicates with a target system, and the at least one processor is configured to run a computer program or instructions, to perform the method according to any one of the first aspect, the second aspect, or the possible implementations of the first aspect or the second aspect.

According to a tenth aspect, this application provides a computing system, including at least one processor and a communication interface, where the communication interface and the at least one processor are interconnected via a line, the communication interface communicates with a target system, and the at least one processor is configured to run a computer program or instructions, to perform the method according to any one of the first aspect, the second aspect, or the possible implementations of the first aspect or the second aspect.

### BRIEF DESCRIPTION OF THE DRAWINGS

FIG. 1 is a diagram of a system architecture according to an embodiment of this application;

FIG. 2 is a diagram of another system architecture according to an embodiment of this application;

FIG. 3 is a flowchart of a signal transmission method according to an embodiment of this application;

FIG. 4 is a flowchart of a signal transmission method according to an embodiment of this application;

FIG. 5 is a diagram of a structure of a signal transmission apparatus according to an embodiment of this application;

FIG. 6 is a diagram of a structure of a signal transmission apparatus according to another embodiment of this application; and

FIG. 7 is a diagram of a structure of a signal transmission apparatus according to an embodiment of this application.

### DETAILED DESCRIPTION OF ILLUSTRATIVE EMBODIMENTS

The following describes the technical solutions in embodiments of this application with reference to the accompanying drawings in embodiments of this application. Clearly, the described embodiments are merely some rather than all of embodiments of this application. All other embodiments obtained by a person of ordinary skill in the art based on embodiments of this application without creative efforts shall fall within the scope of the protection of this application.

A signal transmission method and a related apparatus provided in this application are applicable to a 5th generation (5th generation, 5G) mobile communication new radio (New Radio, NR) system or another communication system, such as a next generation (6th generation) mobile communication system, provided that the communication system includes a first entity and a second entity. The first entity is an entity for sending configuration information, and the second entity is an entity for receiving configuration information. The first entity sends configuration information to the second entity, and sends data to the second entity, or receives data sent by the second entity. The second entity receives the configuration information sent by the first entity, and sends the data to the first entity based on the received configuration information, or receives the data sent by the first entity.

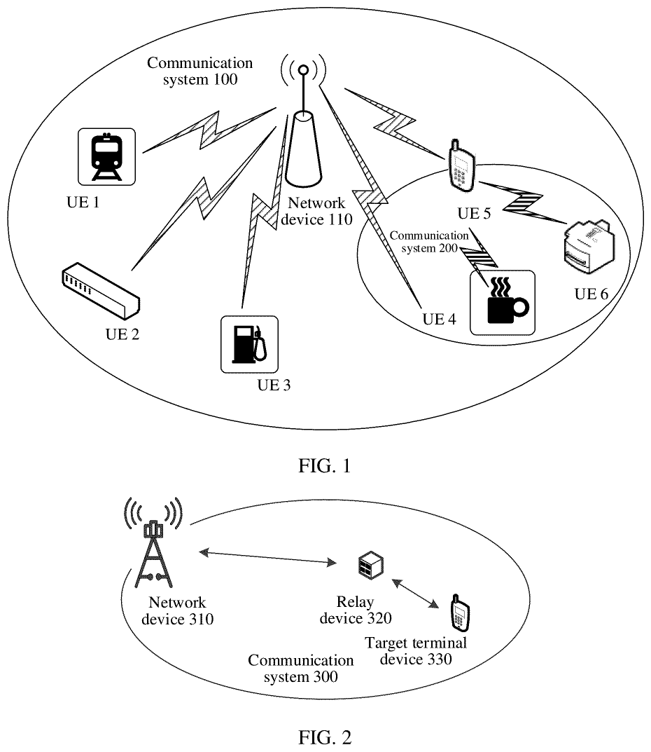

In an example, FIG. 1 is a diagram of a system architecture according to an embodiment of this application. As shown in FIG. 1, a communication system 100 may include a network device 110 and a terminal device (user equipment, UE) 1 to a terminal device 6 (UE 6). The network device 110 is an entity for sending configuration information, the terminal device 1 (UE 1) to the terminal device 6 are entities for receiving configuration information, and the terminal device 1 to the terminal device 6 access the network device 110 in a passive random multiple access manner.

For example, in the communication system 100, the network device 110 may send configuration information to the terminal device 1 to the terminal device 6, the terminal device 1 to the terminal device 6 may send uplink data to the network device 110 based on the received configuration information, and the network device 110 receives the uplink data sent by the terminal device 1 to the terminal device 6.

For example, a terminal device 4 (UE 4) to the terminal device 6 may form a communication system 200. In this case, both the entity for sending configuration information and the entity for receiving configuration information are terminal devices. A terminal device 5 (UE 5) is the entity for sending configuration information, the terminal device 4 and the terminal device 6 are the entities for receiving configuration information, and the terminal device 4 and the terminal device 6 access the terminal device 5 in a passive random multiple access manner. The terminal device 5 sends configuration information to the terminal device 4 and the terminal device 6, and receives data sent by the terminal device 4 and the terminal device 6. The terminal device 4 and the terminal device 6 receive the configuration information sent by the terminal device 5, and send the data to the terminal device 5. An example of the communication system 200 may be an internet of vehicles system.

In another example, FIG. 2 is a diagram of another system architecture according to an embodiment of this application. As shown in FIG. 2, a communication system 300 may be a single-hop (single-hop) or multi-hop (multi-hop) relay system with a relay node. The communication system 300 may include a network device 310, a relay device 320, and a target terminal device 330. The relay node may be in a form of a small cell, an integrated access and backhaul (integrated access and backhauling, IAB) node, a distributed unit (distributed unit, DU), a terminal, a transmission reception point (transmitter and receiver point, TRP), or the like.

For example, the network device 310 sends configuration information to the target terminal device 330 through the relay device 320, and receives, through the relay device 320, data sent by the target terminal device 330. The target terminal device 330 receives, through the relay device 320, the configuration information sent by the network device 310, and sends the data to the network device 310 through the relay device 320.

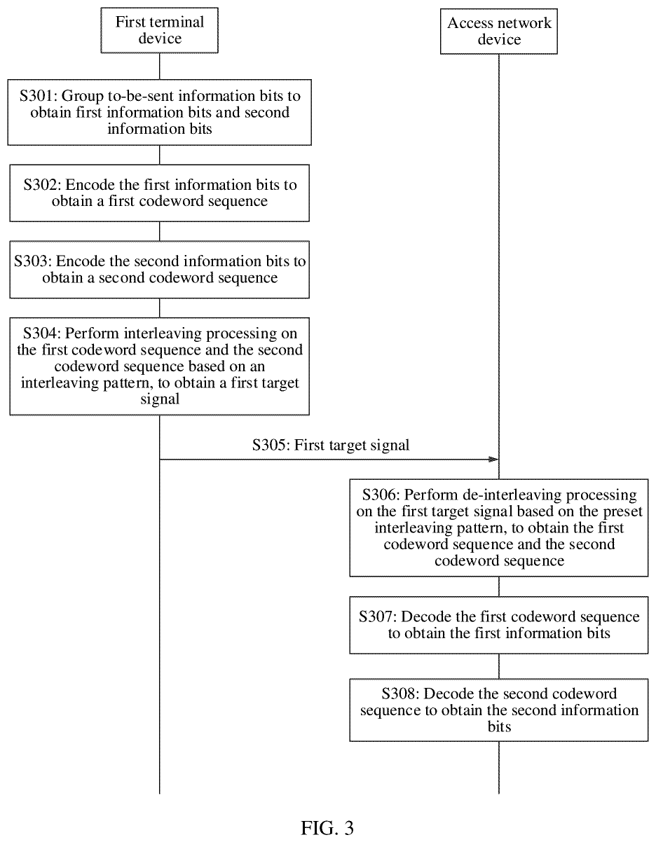

FIG. 3 is a flowchart of a signal transmission method according to an embodiment of this application. As shown in FIG. 3, the method includes at least S301 to S308. A first terminal device accesses an access network device in a passive random multiple access manner.

S301: The first terminal device groups to-be-sent information bits to obtain first information bits and second information bits.

In an example, the first terminal device may be any one of the terminal device 1 to the terminal device 6 in the communication system 100 in FIG. 1.

In another example, the first terminal device may be the terminal device 4 or the terminal device 6 in the communication system 200 in FIG. 1.

In still another example, the first terminal device may be the target terminal device 330 in the communication system 300 in FIG. 2.

In an example, the first terminal device groups to-be-sent information bits w to obtain first information bits wₚ and second information bits w_{c}.

For example, the to-be-sent information bits are w=[0 1 0 0 1 0 0 1 0 1], and the to-be-sent information bits are grouped to obtain the first information bits wₚ=[0 1 0 0 1] and the second information bits w_{c}=[0 0 1 0 1].

S302: The first terminal device encodes the first information bits to obtain a first codeword sequence.

In a possible implementation, the first terminal device receives second configuration information from the access network device. The second configuration information indicates a codebook set. The codebook set is constructed by the access network device in a tensor manner or a matrix extraction manner. The first terminal device performs selection from the codebook set based on the first information bits, to obtain the first codeword sequence.

In an example, the access network device may be the network device 110 in FIG. 1.

In another example, the access network device may be the network device 310 in FIG. 2.

In a possible implementation, the first terminal device selects a codeword sequence from the codebook set based on the first information bits, to obtain the first codeword sequence.

In an example, a quantity of codeword sequences in the codebook set satisfies the following relational expression:

M=2^{P}, where

M represents the quantity of codeword sequences in the codebook set, and P represents a quantity of bits of the first information bits. For example, the quantity of bits of the first information bits wₚ=[0 1 0 0 1] is 5, in other words, a value of P is 5. Corresponding M obtained through calculation based on the foregoing equation is 32, in other words, the quantity of codeword sequences in the codebook set is 32.

For example, if a value obtained by converting the first information bits wₚ=[0 1 0 0 1] to a decimal is 9, the first terminal device selects, from the codebook set, a codeword sequence corresponding to a ninth column as the first codeword sequence.

S303: The first terminal device encodes the second information bits to obtain a second codeword sequence.

In a possible implementation, the first terminal device encodes the second information bits based on a channel encoding/decoding type and a non-orthogonal multiple access type, to obtain the second codeword sequence.

For example, the non-orthogonal multiple access type may include sparse code multiple access (sparse code multiple access, SCMA), multi-user shared access (multi-user shared access, MUSA), interleave-division multiple-access (interleaving division multiple access, IDMA), interleave-gate multiple access (interleave-grid multiple access, IGMA), and the like.

For example, the channel encoding/decoding type may include an LDPC code, a polar (Polar) code, a turbo code, and the like.

In an example, the first terminal device receives third configuration information from the access network device. The third configuration information indicates the channel encoding/decoding type and the non-orthogonal multiple access type. The first terminal device encodes the second information bits based on the channel encoding/decoding type and the non-orthogonal multiple access type that are indicated by the access network device, to obtain the second codeword sequence.

In an example, the first terminal device determines a parameter of the non-orthogonal multiple access type based on the first information bits.

For example, the first information bits wₚ may be used as an input parameter to construct a non-orthogonal multiple access signature sequence. For example, when the non-orthogonal multiple access type indicated by the access network device is the SCMA, the first terminal device may determine, based on the first information bits wₚ, information such as sparseness of an SCMA signature sequence. When the non-orthogonal multiple access type indicated by the access network device is the MUSA, the first terminal device may determine, based on the first information bits wₚ a type of a signature sequence used for the MUSA. The type of the signature sequence used for the MUSA may include inverse discrete Fourier transform (discrete Fourier transform, DFT), a Hadamard (Hadamard) matrix, a Zadoff-Chu (ZC) sequence, and the like.

It should be noted that, for a process of encoding the second information bits based on the channel encoding/decoding type and the non-orthogonal multiple access type to obtain the second codeword sequence, refer to a process of transmitting a signal by using a channel encoding/decoding type and a non-orthogonal multiple access model in the conventional technology. Details are not described herein again.

S304: The first terminal device performs interleaving processing on the first codeword sequence and the second codeword sequence based on an interleaving pattern, to obtain a first target signal.

In a possible implementation, the first terminal device receives first configuration information from the access network device. The first configuration information indicates the interleaving pattern. The first terminal device performs interleaving processing on the first codeword sequence and the second codeword sequence based on the interleaving pattern indicated by the access network device, to obtain the first target signal.

In an example, the interleaving pattern satisfies the following relational expression:

s=h(cell_{id},ratio), where

s represents the interleaving pattern, h(⋅) represents an interleaving function, cell_{id} represents an identity of a cell in which the first terminal device is located, and ratio represents a ratio of a length of the first codeword sequence to a length of the second codeword sequence.

S305: The first terminal device sends the first target signal to the access network device.

In a possible implementation, the first terminal device serves as an end for receiving configuration information, to receive the first configuration information, the second configuration information, and the third configuration information that are sent by the access network device, and sends the first target signal to the access network device based on the configuration information.

In another possible implementation, the first terminal device may serve as an end for transmitting configuration information, to receive a second target signal from a second terminal device, perform de-interleaving processing on the second target signal to obtain a third codeword sequence and a fourth codeword sequence, and then separately decode the third codeword sequence and the fourth codeword sequence to obtain third information bits and fourth information bits.

In an example, the first terminal device in this possible implementation may be the terminal device 5 in the communication system 200 in FIG. 1, and the second terminal device may be the terminal device 4 or the terminal device 6 in the communication system 200 in FIG. 1.

S306: The access network device performs de-interleaving processing on the first target signal based on the preset interleaving pattern, to obtain the first codeword sequence and the second codeword sequence.

In a possible implementation, the access network device determines the interleaving pattern, and sends the first configuration information to the first terminal device. The first configuration information indicates the interleaving pattern.

In an example, the interleaving pattern may be pre-specified in a protocol, and is indicated by the access network device to the first terminal device in a broadcast manner.

In another example, the access network device generates the interleaving pattern online, and sends the determined interleaving pattern to the first terminal device in a broadcast manner.

In still another example, the access network device broadcasts, to the first terminal device, a parameter required for an interleaving pattern used by a resource mapping interleaver, and the first terminal device generates the interleaving pattern based on the received parameter.

In an example, the interleaving pattern satisfies the following relational expression:

s=h(cell_{id},ratio), where

s represents the interleaving pattern, h(⋅) represents an interleaving function, cell_{id} represents an identity of a cell in which the first terminal device is located, and ratio represents a ratio of a length of the first codeword sequence to a length of the second codeword sequence. The interleaving pattern may be generated using a random mapping function.

In an example, the interleaving pattern may be constructed using a layer-based sequence construction method, and specific steps include the following steps.

Step 1: Initialize a 1^{st} layer sequence. To ensure that interleaving patterns of users in a same cell are the same, the identity cell_{id} of the cell in which the first terminal device is located may be used as a seed to initialize a binary sequence. For example, when the identity of the cell in which the first terminal device is located is cell_{id}=[1 0 1 1 0], an initial sequence may be set to [d p d d p]. A symbol “d” represents data, and a symbol “p” represents a pilot. Using cell_{id} as the seed for initialization ensures sequence randomness.

Step 2: Generate an l^{th} (l>1) layer sequence according to the following rules:
(1) Each symbol “d” at an (l−1)^{th} layer is mapped to m symbols “p” and n symbols “d”.
(2) Each symbol “p” at the (l−1)^{th} layer is mapped to k symbols “d”.

m, n, and k>0 and continuous layering is performed based on the foregoing rules, so that a random binary sequence whose initial seed is cell_{id} may be obtained, and indicates a pilot or a data symbol sent on each resource unit. When a length of a binary sequence obtained by layering exceeds a preset value L, the layering is stopped. The preset value L is equal to a quantity of available resource units.

For example, in a random binary sequence whose length is L and obtained by using the foregoing method, a ratio of a data resource to a pilot resource satisfies the following equation:

$$ratio = \frac{1}{2} [ \frac{n}{m} + \sqrt{{( \frac{n}{m} )}^{2} + 4 \frac{k}{m}} ] .$$

In a specific implementation, values of parameters m, n, and k may be determined in a table lookup manner based on an expected ratio ratio of the data resource to the pilot resource. For example, Table 1 shows mapping relationships between different ratios and the parameters m, n, and k.

TABLE 1

| ratio | m | n | k |
|---|---|---|---|
| 2:1 | 1 | 1 | 2 |
| 3:1 | 1 | 1 | 6 |
| 4:1 | 1 | 1 | 12 |
| 5:1 | 1 | 1 | 20 |

For example, as shown in Table 1, when the expected ratio of the data resource to the pilot resource is ratio=2:1, m=1, n=2, and k=2 may be determined. Table 2 shows a result of constructing first four layers of sequences based on an initial symbol “d” by using the parameters.

TABLE 2

| Layer | | | | | | | | | Quantity | Quantity |
|---|---|---|---|---|---|---|---|---|---|---|
| number | Sequence | | | | | | | | of ″d″ | of ″p″ |
| L₁ | d | | | | | | | | 1 | 0 |
| L₂ | $\underbrace{p}_{m = 1} \underbrace{dd}_{n = 2}$ | | | | | | | | 2 | 1 |
| L₃ | $\underbrace{dd}_{k = 2}$ | $\underbrace{p}_{m = 1} \underbrace{dd}_{n = 2}$ | $\underbrace{p}_{m = 1} \underbrace{dd}_{n = 2}$ | | | | | | 6 | 2 |
| L₄ | $\underbrace{p}_{m = 1} \underbrace{dd}_{n = 2}$ | $\underbrace{p}_{m = 1} \underbrace{dd}_{n = 2}$ | $\underbrace{dd}_{k = 2}$ | $\underbrace{p}_{m = 1} \underbrace{dd}_{n = 2}$ | $\underbrace{p}_{m = 1} \underbrace{dd}_{n = 2}$ | $\underbrace{dd}_{k = 2}$ | $\underbrace{p}_{m = 1} \underbrace{dd}_{n = 2}$ | $\underbrace{p}_{m = 1} \underbrace{dd}_{n = 2}$ | 16 | 6 |

| | | | |
|---|---|---|---|
| . . . | . . . | . . . | . . . |

S307: The access network device decodes the first codeword sequence to obtain the first information bits.

In a possible implementation, the access network device constructs the codebook set in the tensor manner or the matrix extraction manner, and sends the second configuration information to the first terminal device. The second configuration information indicates the codebook set.

In an example, the codebook set may be pre-specified in a protocol, and is indicated by the access network device to the first terminal device in a broadcast manner.

In another example, the access network device generates a codebook set online and sends the constructed codebook set to the first terminal device in a broadcast manner.

In still another example, the access network device broadcasts, to the first terminal device, a parameter required for constructing the codebook set, and the first terminal device generates the codebook set based on the received parameter.

In a possible implementation, the codebook set A=[a₁ a₂ . . . a_{M}] may be generated based on a method such as tensor or matrix extraction. For example, when the codebook set is generated based on the tensor method, a sequence aᵢ, i∈[1,M] in the codebook set A may be generated using the following expression:

aᵢ=sᵢ₁⊗sᵢ₁⊗ . . . ⊗s_{iN}, where

the symbol ⊗ represents a Kronecker product operation for vectors, Sᵢ₁ . . . S_{iN} represent preset complex number sequences, N represents a quantity of segments of a complex number sequence, and N is a positive integer greater than or equal to 2.

For another example, when the codebook set is constructed based on the matrix extraction method, the codebook set A may be generated based on an M×M square matrix X, and the square matrix includes the following types:
(1) DFT matrix: For the DFT matrix, an element in a p^{th} row and a q^{th} column in the matrix X may be written as x_{pq}=ω^{pq}. ω=e^{-2πi/M}, and i is an imaginary unit, that is, i²=−1.
(2) IDFT matrix: For the IDFT matrix, x_{pq}=ω^{-pq}, and ω=e^{-2πi/M}.
(3) Hadamard matrix: For a 1^{st}-order Hadamard matrix,

$${X}_{1} = [ \begin{matrix}1 & 1 \\ 1 & - 1\end{matrix} ] .$$

For an M^{th}-order (M>1) Hadamard matrix, there is the following recursive form,

$${X}_{M} = [ \begin{matrix}{X}_{M - 1} & {X}_{M - 1} \\ {X}_{M - 1} & - {X}_{M - 1}\end{matrix} ] .$$

(4) ZC matrix: First, a ZC sequence with a length M is generated based on a method provided in NR TS 38.211. The length M needs to be coprime with a root of the ZC sequence. The ZC matrix X is formed by performing M cyclic shifts on the ZC sequence.

L (L<M) rows are extracted from the matrix X, to form a codebook set A of L rows and M columns, and each column in the matrix may be used as a transmission codeword sequence.

In a possible implementation, the access network device decodes the first codeword sequence based on the constructed codebook set, to obtain the first information bits.

In an example, the access network device detects the first codeword sequence, and determines the first information bits wₚ based on a detection result. The detection on the first codeword sequence may be based on an algorithm such as correlation detection or compression sensing.

For example, when the correlation detection method is used, the access network device calculates a correlation coefficient between each codeword in the codebook set A=[a₁ a₂ . . . a_{M}] and the first codeword sequence y. A correlation coefficient between a codeword sequence aᵢ in the codebook set A and the first codeword sequence y satisfies the following equation:

$${ρ}_{i} = {y}^{H} {a}_{i} , i = 1 , 2 , … , M .$$

A subscript of an activated codeword sequence is iₘₐₓ=arg max_{i∈[1,M]}|ρᵢ|, and then the to-be-transmitted bits wₚ are determined based on the subscript iₘₐₓ of the activated codeword sequence.

In an example, a subscript value corresponding to a codeword sequence that is in the codebook set A and that has a maximum correlation coefficient with the first codeword sequence y is obtained through calculation. The first information bits are determined based on the subscript value and a quantity of bits in the first information bits.

For example, the quantity of bits in the first information bits satisfies the following equation:

P=log₂M, where

P represents the quantity of bits in the first information bits, and M represents a quantity of codeword sequences in the codebook set.

For example, it is assumed that the calculated subscript value corresponding to the codeword sequence that is in the codebook set A and that has the maximum correlation coefficient with the first codeword sequence y is 9, and a value of M is 32. In this case, a value of P obtained through calculation based on the foregoing equation is 5. In other words, the quantity of bits in the first information bits is 5. The subscript value of 9 is converted into a binary sequence having five bits, to obtain the first information bits, that is, the first information bits wₚ=[0 1 0 0 1].

S308: The access network device decodes the second codeword sequence to obtain the second information bits.

In a possible implementation, the access network device determines the channel encoding/decoding type and the non-orthogonal multiple access type, and sends the third configuration information to the first terminal device. The third configuration information indicates the channel encoding/decoding type and the non-orthogonal multiple access type. In addition, the access network device decodes the second codeword sequence based on the channel encoding/decoding type and the non-orthogonal multiple access type, to obtain the second information bits.

For example, the non-orthogonal multiple access type may include SCMA, MUSA, IDMA, and IGMA.

For example, the channel encoding/decoding type may include an LDPC code, a polar code, a turbo code, and the like.

In an example, the access network device determines the parameter of the non-orthogonal multiple access type based on the first information bits.

For example, when the non-orthogonal multiple access type determined by the access network device is the SCMA, information such as sparseness of an SCMA signature sequence may be determined based on the first information bits wₚ. When the non-orthogonal multiple access type determined by the access network device is the MUSA, a type of a signature sequence used by the MUSA may be determined based on the first information bits wₚ. The type of the signature sequence used by the MUSA may include DFT, Hadamard, a ZC matrix, and the like.

It should be noted that, for a process of decoding the second codeword sequence based on the channel encoding/decoding type and the non-orthogonal multiple access type to obtain the second information bits, refer to the process of transmitting a signal by using a channel encoding/decoding type and a non-orthogonal multiple access model in the conventional technology. Details are not described herein again. According to the technical solutions provided in this application, the first terminal device accesses the access network device in the passive random multiple access manner. The first terminal device separately encodes the first information bits and the second information bits to obtain the first codeword sequence and the second codeword sequence. The first codeword sequence is equivalent to a pilot, and the second codeword sequence includes to-be-transmitted information. Then, the first terminal device performs interleaving processing on the first codeword sequence and the second codeword sequence based on the interleaving pattern, to obtain the first target signal, and sends the first target signal to the access network device. The access network device performs, based on the preset interleaving pattern, de-interleaving processing on the first target signal received from the first terminal device, to obtain the first codeword sequence and the second codeword sequence, and separately decodes the first codeword sequence and the second codeword sequence to obtain the first information bits and the second information bits. In the target signal obtained by performing interleaving processing on the first codeword sequence and the second codeword sequence based on the interleaving pattern, the first codeword sequence and the second codeword sequence can be distributed as evenly as possible, so that a pilot signal and a to-be-transmitted signal can be evenly distributed. In this way, the obtained target signal is more suitable for a scenario in which a channel changes rapidly, and signal transmission accuracy is improved.

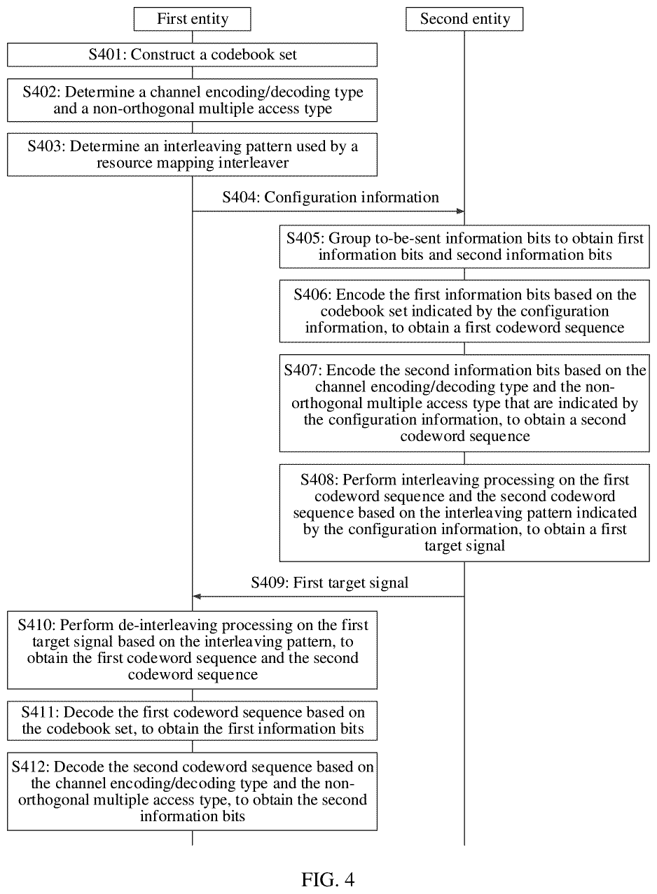

FIG. 4 is a flowchart of a signal transmission method according to an embodiment of this application. As shown in FIG. 4, the method includes at least S401 to S412. A second entity accesses a first entity in a passive random multiple access manner.

S401: The first entity constructs a codebook set.

In an example, the first entity may be the network device 110 in the communication system 100 in FIG. 1.

In another example, the first entity may be the terminal device 5 in the communication system 200 in FIG. 1.

In still another example, the first entity may be the network device 310 in the communication system 300 in FIG. 2.

In a possible implementation, the codebook set A=[a₁ a₂ . . . a_{M}] may be generated based on a method such as tensor or matrix extraction. For example, when the codebook set is generated based on the tensor method, a codeword sequence aᵢ, i∈[1,M] in the codebook set A may be generated using the following expression:

aᵢ=sᵢ₁⊗sᵢ₁⊗ . . . ⊗s_{iN}, where

the symbol ⊗ represents a Kronecker product operation for vectors, Sᵢ₁ . . . S_{iN} represent preset complex number sequences, N represents a quantity of segments of a complex number sequence, and N is a positive integer greater than or equal to 2.

For another example, when the codebook set is constructed based on the matrix extraction method, the codebook set A may be generated based on an M×M square matrix X, and the square matrix includes the following types:
(1) DFT matrix: For the DFT matrix, an element in a p^{th} row and a q^{th} column in the matrix X may be written as x_{pq}=ω^{pq}. ω=e^{-2πi/M} and i is an imaginary unit, that is, i²=−1.
(2) IDFT matrix: For the IDFT matrix, x_{pq}=ω^{-pq}, and ω=e^{-2πi/M}.
(3) Hadamard matrix: For a 1^{st}-order Hadamard matrix,

$${X}_{1} = [ \begin{matrix}1 & 1 \\ 1 & - 1\end{matrix} ] .$$

For an M^{th}-order (M>1) Hadamard matrix, there is the following recursive form,

$${X}_{M} = [ \begin{matrix}{X}_{M - 1} & {X}_{M - 1} \\ {X}_{M - 1} & - {X}_{M - 1}\end{matrix} ] .$$

(4) ZC matrix: First, a ZC sequence with a length M is generated based on a method provided in NR TS 38.211. The length M needs to be coprime with a root of the ZC sequence. The ZC matrix X is formed by performing M cyclic shifts on the ZC sequence.

L (L<M) rows are extracted from the matrix X, to form a codebook set A of L rows and M columns, and each column in the matrix may be used as a transmission codeword sequence.

S402: The first entity determines a channel encoding/decoding type and a non-orthogonal multiple access type.

In an example, the channel encoding/decoding type may include an LDPC code, a polar code, a turbo code, and the like. The first entity selects any one of the channel encoding/decoding types.

In an example, the non-orthogonal multiple access type may include SCMA, MUSA, IDMA, and IGMA. The first entity selects any one of the non-orthogonal multiple access types.

S403: The first entity determines an interleaving pattern used by a resource mapping interleaver.

In an example, the interleaving pattern satisfies the following relational expression:

s=h(cell_{id},ratio), where

s represents the interleaving pattern, h(⋅) represents an interleaving function, cell_{id} represents an identity of a cell in which the second entity is located, and ratio represents a pilot resource ratio. The interleaving pattern may be generated using a random mapping function.

In an example, the interleaving pattern may be constructed using a layer-based sequence construction method, and specific steps include the following steps.

Step 1: Initialize a 1^{st} layer sequence. To ensure that interleaving patterns of users in a same cell are the same, the identity cell_{id} of the cell in which the first terminal device is located may be used as a seed to initialize a binary sequence. For example, when the identity of the cell in which the first terminal device is located is cell_{id}=[10110], an initial sequence may be set to [d p d d p]. A symbol “d” represents data, and a symbol “p” represents a pilot. Using cell_{id} as the seed for initialization ensures sequence randomness.

Step 2: Generate an l^{th} (l>1) layer sequence according to the following rules:
(1) Each symbol “d” at an (l−1)^{th} layer is mapped to m symbols “p” and n symbols “d”.
(2) Each symbol “p” at the (l−1)^{th} layer is mapped to k symbols “d”.

m, n, and k>0, and continuous layering is performed based on the foregoing rules, so that a random binary sequence whose initial seed is cell_{id} may be obtained, and indicates a pilot or a data symbol sent on each resource unit. When a length of a binary sequence obtained by layering exceeds a preset value L, the layering is stopped. The preset value L is equal to a quantity of available resource units.

For example, in a random binary sequence whose length is L and obtained by using the foregoing method, a ratio of a data resource to a pilot resource satisfies the following equation:

$$ratio = \frac{1}{2} [ \frac{n}{m} + \sqrt{{( \frac{n}{m} )}^{2} + 4 \frac{k}{m}} ] .$$

In a specific implementation, values of parameters m, n, and k may be determined in a table lookup manner based on an expected ratio ratio of the data resource to the pilot resource. For example, for mapping relationships between different ratio s and the parameters m, n, and k, refer to Table 1.

For example, as shown in Table 1, when the expected ratio of the data resource to the pilot resource is ratio=2:1, m=1, n=2, and k=2 may be determined. For a result of constructing first four layers of sequences based on an initial symbol “d” by using the parameters, refer to Table 2.

S404: The first entity sends configuration information to the second entity, where the configuration information indicates the codebook set, the channel encoding/decoding type, the non-orthogonal multiple access type, and the interleaving pattern.

In a possible implementation, the codebook set and/or the interleaving pattern may be pre-specified in a protocol, and the first entity indicates a configuration result to the second entity in a broadcast manner.

In another possible implementation, the codebook set and/or the interleaving pattern may be generated in an online manner, and the first entity sends the codebook set and the interleaving pattern to the second entity in a broadcast manner.

In still another possible implementation, the first entity sends, to the second entity in a broadcast manner, a parameter required for generating the codebook set and/or the interleaving pattern, and the second entity generates the codebook set and/or the interleaving pattern based on the received parameter.

S405: The second entity groups to-be-sent information bits to obtain first information bits and second information bits.

In an example, the second entity may be the terminal device 1 to the terminal device 6 in the communication system 100 in FIG. 1.

In another example, the second entity may be the terminal device 4 and the terminal device 6 in the communication system 200 in FIG. 1.

In still another example, the second entity may be the target terminal device 330 in the communication system 300 in FIG. 2.

In an example, a quantity of codeword sequences in the codebook set A=[a₁ a₂ . . . a_{M}] received by the second entity is M, and a quantity P of bits of the first information bits obtained by grouping the to-be-sent information bits by the second entity satisfies the following equation:

P=log₂M.

For example, the to-be-sent information bits are w=[0 1 0 0 1 0 0 1 0 1], and a value of the quantity M of codeword sequences in the codebook set A received by the second entity is 32. In this case, the quantity P of bits of the first information bits may be calculated as 5 based on the foregoing equation. The to-be-sent information bits are grouped, and first five bits in the to-be-sent information bits are denoted as the first information bits wₚ, where wₚ=[0 1 0 0 1]. Remaining bits in the to-be-sent information bits are denoted as the second information bits w_{c}, where w_{c}=[0 0 1 0 1].

S406: The second entity encodes the first information bits based on the codebook set indicated by the configuration information, to obtain a first codeword sequence.

In an example, if a value obtained by converting the first information bits wₚ=[0 1 0 0 1] to a decimal is 9, the second entity selects, from the codebook set A=[a₁ a₂ . . . a_{M}], a codeword sequence corresponding to a ninth column as the first codeword sequence.

S407: The second entity encodes the second information bits based on the channel encoding/decoding type and the non-orthogonal multiple access type that are indicated by the configuration information, to obtain a second codeword sequence.

In an example, the second entity determines a parameter of the non-orthogonal multiple access type based on the first information bits wₚ.

For example, the first information bits wₚ may be used as an input parameter to construct a non-orthogonal multiple access signature sequence. For example, when the non-orthogonal multiple access type indicated by the first entity is the SCMA, the second entity may determine information such as sparseness of an SCMA signature sequence based on the first information bits wₚ. When the non-orthogonal multiple access type indicated by the first entity is the MUSA, the second entity may determine, based on the first information bits wₚ a type of a signature sequence used by the MUSA. The type of the signature sequence used by the MUSA may include DFT, Hadamard, a ZC matrix, and the like.

It should be noted that, for a process of encoding the second information bits based on the channel encoding/decoding type and the non-orthogonal multiple access type to obtain the second codeword sequence, refer to a process of transmitting a signal by using a channel encoding/decoding type and a non-orthogonal multiple access model in the conventional technology. Details are not described herein again.

S408: The second entity performs interleaving processing on the first codeword sequence and the second codeword sequence based on the interleaving pattern indicated by the configuration information, to obtain a first target signal.

In the first target signal obtained by performing interleaving processing on the first codeword sequence and the second codeword sequence based on the interleaving pattern, the first codeword sequence and the second codeword sequence are scattered, and distributed as evenly as possible.

S409: The second entity sends the first target signal to the first entity.

S410: The first entity performs de-interleaving processing on the first target signal based on the interleaving pattern, to obtain the first codeword sequence and the second codeword sequence.

S411: The first entity decodes the first codeword sequence based on the codebook set, to obtain the first information bits.

In an example, the first entity detects the first codeword sequence, and determines the first information bits wₚ based on a detection result. The detection on the first codeword sequence may be based on an algorithm such as correlation detection or compression sensing.

For example, when the correlation detection method is used, the first entity calculates a correlation coefficient between each codeword in the codebook set A=[a₁ a₂ . . . a_{M}] and a first codeword sequence y obtained by performing de-interleaving processing. A correlation coefficient between a codeword sequence aᵢ in the codebook set A and the first codeword sequence y satisfies the following equation:

$${ρ}_{i} = {y}^{H} {a}_{i} , i = 1 , 2 , … , M .$$

A subscript of an activated codeword sequence is iₘₐₓ=arg max_{i∈[1,M]}|ρᵢ| and then the first information bits wₚ are determined based on the subscript iₘₐₓ of the activated codeword sequence.

In an example, a subscript value corresponding to a codeword sequence that is in the codebook set A and that has a maximum correlation coefficient with the first codeword sequence y is obtained through calculation. The first information bits are determined based on the subscript value and a quantity of bits in the first information bits.

For example, the quantity of bits in the first information bits satisfies the following equation:

P=log₂M, where

P represents the quantity of bits in the first information bits, and M represents a quantity of codeword sequences in the codebook set.

For example, it is assumed that the calculated subscript value corresponding to the codeword sequence that is in the codebook set A and that has the maximum correlation coefficient with the first codeword sequence y is 9, and a value of M is 32. In this case, a value of P obtained through calculation based on the foregoing equation is 5. In other words, the quantity of bits in the first information bits is 5. The subscript value of 9 is converted into a binary sequence having five bits, to obtain the first information bits, that is, the first information bits wₚ=[0 1 0 0 1].

S412: The first entity decodes the second codeword sequence based on the channel encoding/decoding type and the non-orthogonal multiple access type, to obtain the second information bits.

In an example, the first entity determines the parameter of the non-orthogonal multiple access type based on the first information bits wₚ.

It should be noted that, for a process in which the first entity decodes the second codeword sequence based on the channel encoding/decoding type and the non-orthogonal multiple access type to obtain the second information bits, refer to a process of decoding based on a channel encoding/decoding type and a non-orthogonal multiple access type in the conventional technology. Details are not described herein again.

According to the technical solutions provided in this application, a method for constructing the codebook set based on the tensor manner or the matrix extraction is proposed. With reference to an existing channel encoding/decoding type and an existing non-orthogonal multiple access model, the first information bits and the second information bits are encoded and decoded, thereby improving transmission efficiency and accuracy of the to-be-sent information bits. In addition, the first codeword sequence and the second codeword sequence are sent through the resource mapping interleaver in an interleaving manner, so that pilots are distributed on a plurality of transmitted symbols, thereby improving accuracy of channel estimation in a high-speed movement scenario, resolving a resource collision problem in a contention-based random access scenario, and bringing a significant performance gain in a high-speed movement scenario in which a channel rapidly changes.

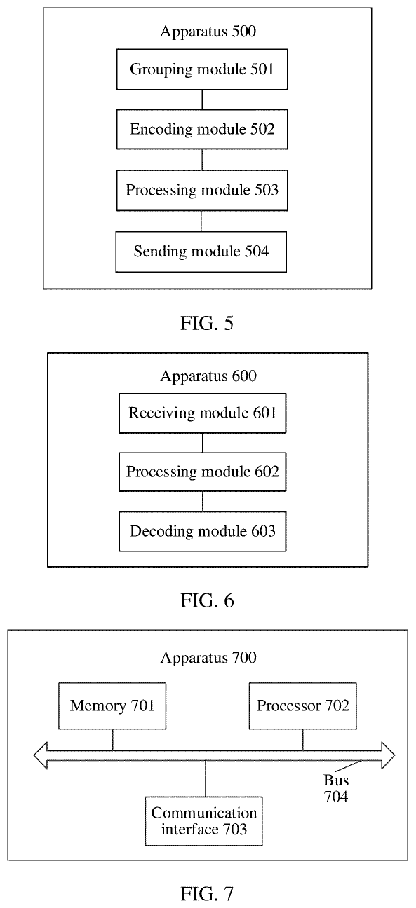

FIG. 5 is a diagram of a structure of a signal transmission apparatus according to an embodiment of this application. As shown in FIG. 5, the apparatus 500 may include a grouping module 501, an encoding module 502, a processing module 503, and a sending module 504. The apparatus 500 may be configured to implement the operations implemented by the first terminal device or the second entity in FIG. 3 and FIG. 4.

A part or all of the grouping module, the encoding module, the processing module, and the sending module in this embodiment of this application may be implemented in a software manner and/or a hardware manner. A part implemented using software may run on a processor to implement a corresponding function, and a part implemented using hardware may be a component of the processor.

In an implementation, the apparatus 500 may be configured to implement the method shown in FIG. 3. For example, the grouping module 501 is configured to implement S301, the encoding module 502 is configured to implement S302 and S303, the processing module 503 is configured to implement S304, and the sending module 504 is configured to implement S305.

In another implementation, the apparatus 500 may further include a receiving module, and the apparatus 500 in this implementation may be configured to implement the method shown in FIG. 4. For example, the grouping module 501 is configured to implement S405, the encoding module 502 is configured to implement S406 and S407, the processing module 503 is configured to implement S408, the sending module 504 is configured to implement S409, and the receiving module is configured to implement S404.

FIG. 6 is a diagram of a structure of a signal transmission apparatus according to another embodiment of this application. As shown in FIG. 6, the apparatus 600 may include a receiving module 601, a processing module 602, and a decoding module 603. The apparatus 600 may be configured to implement the operations implemented by the access network device or the first entity in FIG. 3 and FIG. 4.

A part or all of the receiving module, the processing module, and the decoding module in this embodiment of this application may be implemented in a software manner and/or a hardware manner. A part implemented using software may run on a processor to implement a corresponding function, and a part implemented using hardware may be a component of the processor.

In an implementation, the apparatus 600 may be configured to implement the method shown in FIG. 3. For example, the receiving module 601 is configured to implement S305, the processing module 602 is configured to implement S306, and the decoding module 603 is configured to implement S307 and S308.

In another implementation, the apparatus 600 may further include a construction module, a determining module, and a sending module. The apparatus 600 in this implementation may be configured to implement the method shown in FIG. 4. For example, the receiving module 601 is configured to implement S409, the processing module 602 is configured to implement S410, the decoding module 603 is configured to implement S411 and S412, the construction module is configured to implement S401, the determining module is configured to implement S402 and S403, and the sending module is configured to implement S404.

FIG. 7 is a diagram of a structure of a signal transmission apparatus according to an embodiment of this application. The apparatus 700 shown in FIG. 7 may be configured to perform the method according to any one of the foregoing embodiments.

As shown in FIG. 7, the apparatus 700 in this embodiment includes a memory 701, a processor 702, a communication interface 703, and a bus 704. The memory 701, the processor 702, and the communication interface 703 implement mutual communication connections through the bus 704.

The memory 701 may be a read-only memory (read-only memory, ROM), a static storage device, a dynamic storage device, or a random access memory (random access memory, RAM). The memory 701 may store a program. When the program stored in the memory 701 is executed by the processor 702, the processor 702 may be configured to perform the steps of the methods shown in FIG. 3 to FIG. 4.

The processor 702 may be a general-purpose central processing unit (central processing unit, CPU), a microprocessor, an application-specific integrated circuit (application-specific integrated circuit, ASIC), or one or more integrated circuits, configured to execute a related program, to implement the signal transmission method in the method embodiments of this application.

The processor 702 may alternatively be an integrated circuit chip, and has a signal processing capability. In an implementation process, the steps of the methods in embodiments of this application may be completed using an integrated logic circuit of hardware in the processor 702 or using instructions in a form of software.

The processor 702 may alternatively be a general-purpose processor, a digital signal processor (digital signal processor, DSP), an application-specific integrated circuit (ASIC), a field programmable gate array (field programmable gate array, FPGA) or another programmable logic device, a discrete gate or a transistor logic device, or a discrete hardware component. The processor 702 may implement or execute the methods, the steps, and logical block diagrams that are disclosed in embodiments of this application. The general-purpose processor may be a microprocessor, or the processor may be any conventional processor or the like.

The steps in the methods disclosed with reference to embodiments of this application may be directly performed and completed by a hardware decoding processor, or may be performed and completed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory 701, and the processor 702 reads information in the memory 701, and completes, by using hardware of the processor 702, functions that need to be performed in the methods in embodiments of this application. For example, the processor 702 may perform the steps/functions in the embodiments shown in FIG. 3 and FIG. 4.

The communication interface 703 may be but is not limited to a transceiver apparatus like a transceiver, to implement communication between the apparatus 700 and another device or a communication network.

The bus 704 may include a path for transferring information between the components (for example, the memory 701, the processor 702, and the communication interface 703) of the apparatus 700.

It should be understood that the apparatus 700 shown in this embodiment of this application may be an electronic device, or may be a chip configured in an electronic device.

It should be understood that the processor in this embodiment of this application may be a central processing unit (central processing unit, CPU). The processor may alternatively be another general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or transistor logic device, or a discrete hardware component. The general-purpose processor may be a microprocessor, or the processor may be any conventional processor or the like.

It may be understood that the memory in this embodiment of this application may be a volatile memory or a non-volatile memory, or may include a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM) that is used as an external cache. Through an example rather than a limitative description, random access memories (RAMs) in many forms may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

A part or all of the foregoing embodiments may be implemented using software, hardware, firmware, or any combination thereof. When the software is used to implement embodiments, the foregoing embodiments may be implemented completely or partially in a form of a computer program product. The computer program product includes one or more computer instructions or computer programs. When the computer instructions or the computer programs are loaded and executed on a computer, the procedures or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk drive, or a magnetic tape), an optical medium (for example, a DVD), or a semiconductor medium. The semiconductor medium may be a solid-state drive.

It should be understood that the term “and/or” in this specification describes only an association relationship between associated objects and indicates that three relationships may exist. For example, A and/or B may indicate the following three cases: Only A exists, both A and B exist, and only B exists. A and B may be singular or plural. In addition, the character “/” in this specification usually indicates an “or” relationship between the associated objects, but may also indicate an “and/or” relationship. For details, refer to the context for understanding.

In this application, “at least one” means one or more, and “a plurality of” means two or more. “At least one of the following items (pieces)” or a similar expression thereof means any combination of these items, including a singular item (piece) or any combination of plural items (pieces). For example, at least one of a, b, or c may indicate: a, b, c, a-b, a-c, b-c, or a-b-c, where a, b, and c may be singular or plural.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electrical form, a mechanical form, or other forms.

The units described as separate parts may or may not be physically separate, and parts displayed as units may or may not be physical units, may be located in one position, or may be distributed on a plurality of network units. A part or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to the current technology, or a part of the technical solutions may be implemented in a form of a software product. The computer software product is stored in a storage medium, and includes several instructions for instructing a computer device (which may be a personal computer, a server, or a network device) to perform a part or all of the steps of the methods described in embodiments of this application. The foregoing storage medium includes: any medium that can store program code, such as a USB flash disk, a removable hard disk drive, a read-only memory, a random access memory, a magnetic disk, or an optical disc.

The foregoing descriptions are merely specific implementations of this application, but are not intended to limit the scope of the protection of this application. Any variation or replacement readily figured out by a person skilled in the art within the technical scope disclosed in this application shall fall within the scope of the protection of this application. Therefore, the scope of the protection of this application shall be subject to the scope of the protection of the claims.

1-20. (canceled)

21. A method, applied to a first terminal device, wherein the method comprises:
grouping to-be-sent information bits to obtain first information bits and second information bits;
encoding the first information bits to obtain a first codeword sequence;
encoding the second information bits to obtain a second codeword sequence;
performing interleaving processing on the first codeword sequence and the second codeword sequence based on an interleaving pattern to obtain a first target signal; and
sending the first target signal to an access network device, wherein the first terminal device accesses the access network device in a passive random multiple access manner.

22. The method according to claim 21, further comprising:
receiving first configuration information from the access network device, wherein the first configuration information indicates the interleaving pattern.

23. The method according to claim 21, wherein the interleaving pattern satisfies the following relational expression:
s=h(cell_{id},ratio), wherein
s represents the interleaving pattern, h(⋅) represents an interleaving function, cell_{id} represents an identity of a cell in which the first terminal device is located, and ratio represents a ratio of a length of the first codeword sequence to a length of the second codeword sequence.

24. The method according to claim 21, wherein the method further comprises:
receiving second configuration information from the access network device, wherein the second configuration information indicates a codebook set, and the codebook set is constructed by the access network device in a tensor manner or a matrix extraction manner.

25. The method according to claim 24, wherein encoding the first information bits to obtain the first codeword sequence comprises:
performing selection from the codebook set based on the first information bits to obtain the first codeword sequence.

26. The method according to claim 21, wherein encoding the second information bits to obtain the second codeword sequence comprises:
encoding the second information bits based on a channel encoding/decoding type and a non-orthogonal multiple access type to obtain the second codeword sequence.

27. The method according to claim 26, wherein the method further comprises:
receiving third configuration information from the access network device, wherein the third configuration information indicates the channel encoding/decoding type and the non-orthogonal multiple access type.

28. The method according to claim 26, further comprising:
determining a parameter of the non-orthogonal multiple access type based on the first information bits.

29. The method according to claim 21, further comprising:
receiving a second target signal from a second terminal device;
performing de-interleaving processing on the second target signal to obtain a third codeword sequence and a fourth codeword sequence;
decoding the third codeword sequence to obtain third information bits; and
decoding the fourth codeword sequence to obtain fourth information bits.

30. A method, applied to an access network device, wherein the method comprises:
receiving a first target signal from a first terminal device, wherein the first terminal device accesses the access network device in a passive random multiple access manner;
performing de-interleaving processing on the first target signal based on a preset interleaving pattern, to obtain a first codeword sequence and a second codeword sequence;
decoding the first codeword sequence to obtain first information bits; and
decoding the second codeword sequence to obtain second information bits.

31. The method according to claim 30, further comprising:
sending first configuration information to the first terminal device, wherein the first configuration information indicates the interleaving pattern.

32. The method according to claim 30, wherein the interleaving pattern satisfies the following relational expression:
s=h(cell_{id},ratio), wherein
s represents the interleaving pattern, h(⋅) represents an interleaving function, cell_{id} represents an identity of a cell in which the first terminal device is located, and ratio represents a ratio of a length of the first codeword sequence to a length of the second codeword sequence.

33. The method according to claim 30, further comprising:
constructing a codebook set in a tensor manner or a matrix extraction manner, wherein the first information bits is transmitted based on the codebook set; and
sending second configuration information to the first terminal device, wherein the second configuration information indicates the codebook set.

34. The method according to claim 33, wherein decoding the first codeword sequence to obtain first information bits comprises:
decoding the first codeword sequence based on the codebook set, to obtain the first information bits.

35. The method according to claim 31, further comprising:
determining a channel encoding/decoding type and a non-orthogonal multiple access type; and
sending third configuration information to the first terminal device, wherein the third configuration information indicates the channel encoding/decoding type and the non-orthogonal multiple access type.

36. The method according to claim 35, wherein decoding the second codeword sequence to obtain the second information bits comprises:
decoding the second codeword sequence based on the channel encoding/decoding type and the non-orthogonal multiple access type to obtain the second information bits.

37. The method according to claim 35, wherein the method further comprises:
determining a parameter of the non-orthogonal multiple access type based on the first information bits.

38. An apparatus, comprising:
at least one processor; and
a non-transitory computer-readable medium including computer-executable instructions that, when executed by the processor, cause the apparatus to carry out a method including:
grouping to-be-sent information bits to obtain first information bits and second information bits;
encoding the first information bits to obtain a first codeword sequence;
encoding the second information bits to obtain a second codeword sequence; performing interleaving processing on the first codeword sequence and the second codeword sequence based on an interleaving pattern, to obtain a first target signal; and
sending the first target signal to an access network device, wherein the apparatus accesses the access network device in a passive random multiple access manner.

39. The apparatus according to claim 38, wherein the method further comprises:
receiving first configuration information from the access network device, wherein the first configuration information indicates the interleaving pattern, and the interleaving pattern satisfies the following relational expression:
s=h(cell_{d},ratio), wherein
s represents the interleaving pattern, h(⋅) represents an interleaving function, cell_{id} represents an identity of a cell in which the apparatus is located, and ratio represents a ratio of a length of the first codeword sequence to a length of the second codeword sequence.

40. The apparatus according to claim 38, wherein the method further comprises:
receiving second configuration information from the access network device, wherein the second configuration information indicates a codebook set, and the codebook set is constructed by the access network device in a tensor manner or a matrix extraction manner.
